(19) United States
(12) Patent Application Publication
(10) Pub. No.: US 2012/0078632 A1
(43) Pub. Date: Mar. 29, 2012

(54) VOICE-BAND EXTENDING APPARATUS AND VOICE-BAND EXTENDING METHOD

(75) Inventors: Taro Togawa, Kawasaki (JP); Shusaku Ito, Fukuoka (JP); Takeshi Otani, Kawasaki (JP); Masanao Suzuki, Kawasaki (JP); Yasuji Ota, Kawasaki (JP)

(73) Assignee: FUJITSU LIMITED, Kawasaki (JP)

(21) Appl. No.: 13/158,812

(22) Filed: Jun. 13, 2011

(30) Foreign Application Priority Data
Sep. 27, 2010 (JP) 2010-216035

(51) Int. Cl. G10L 13/00

(52) U.S. Cl. 704/258; 704/E13.001

(57) ABSTRACT

An optical device includes a fast Fourier transform (FFT) unit, a signal noise ratio (SNR) calculation processing unit, a band selecting unit, an extension-signal creating unit, an addition unit, and an inverse fast Fourier transform (IFFT) unit. The FFT unit performs the Fourier transform on an input signal that is input from the outside. The SNR calculation processing unit calculates an SNR with respect to each of bands in the input signal. The band selecting unit selects a band of which SNR exceeds a threshold and is the maximum SNR, based on respective SNRs of the bands. The extension-signal creating unit creates an extension signal based on a signal acquired by the band selecting unit. The addition unit adds the extension signal to the input signal, and creates a band-extended signal. The IFFT unit performs the inverse fast Fourier transform on the band-extended signal, and creates an output signal.

### CROSS-REFERENCE TO RELATED APPLICATION

This application is based upon and claims the benefit of priority of the prior Japanese Patent Application No. 2010-216035, filed on Sep. 27, 2010, the entire contents of which are incorporated herein by reference.

### FIELD

The embodiments discussed herein are directed to a voice-band extending apparatus and a voice-band extending method.

### BACKGROUND

Communication tools, such as mobile phones, perform voice communications by removing bass components and treble components of voice signals in order to use a communication band efficiently. However, if bass components and treble components of voice signals are removed, the sound quality is degraded, therefore, a technology to improve a degraded sound quality has been proposed.

For example, there is a conventional technology 1 that improves the sound quality by artificially creating a voice signal of a lost treble component. FIGS. 26 to 28 are schematic diagrams for explaining the conventional technology 1. The horizontal axis in FIGS. 26 to 28 represents the frequency, and the vertical axis represents the volume of sound.

As depicted in FIG. 26, a voice signal is a wide-band signal, for example, zero to six kilohertz. When the wide-band signal is transmitted, if the band is limited from zero to four kilohertz, treble components from four to six kilohertz are lost. In other words, as depicted in FIG. 27, the transmitted voice signal is degraded to a narrow-band signal from zero to four kilohertz. According to the conventional technology 1, the narrow-band signal is received as an input signal, an extension signal for compensating the lost signal is artificially created by using a signal from two to four kilohertz adjacent to the lost band. As depicted in FIG. 28, the extension signal is then added to the narrow-band signal, so that the band from zero to four kilohertz is extended to the band from zero to six kilohertz, accordingly, the sound quality is improved. The signal expressed by a broken line indicates the extension signal.

Moreover, when an input signal includes a lot of noises, a conventional technology 2 that improves the sound quality while suppressing influence of noise is available. FIGS. 29 to 32 are schematic diagrams for explaining the conventional technology 2. According to FIGS. 29 to 32, explained below is a case where treble components from four to six kilohertz are lost, and an extension signal is created by using a signal in an adjacent band from two to four kilohertz. The horizontal axis in FIGS. 29 and 31 represents the frequency, and the vertical axis represents the volume of sound. Shadow parts in FIGS. 29 and 31 indicate the level of noises included in voice signals, and a signal expressed by a broken line indicates an extension signal. Moreover, FIG. 30 indicates the level of signal noise ratio (SNR) corresponding to FIG. 29, and FIG. 32 indicates the level of SNR corresponding to FIG. 31. The SNR indicates a ratio of the level of voice to the level of noise, and the higher value of the SNR, the higher level of voice indicates.

As depicted in FIGS. 29 to 30, according to the conventional technology 2, when the SNR of an adjacent band is high and noises are few, an extension signal is created by using a signal in the adjacent band, thereby improving the sound quality. However, as depicted in FIGS. 31 to 32, when the SNR of an adjacent band is low and noises are a lot; if an extension signal is created by using a signal in the adjacent band, a lot of noises are included, consequently, the sound quality is degraded adversely. For this reason, according to the conventional technology 2, when an extension signal includes a lot of noises, the level of the whole of the extension signal is attenuated, thereby improving the sound quality while suppressing influence of noise.

An example of a configuration of a voice-band extending apparatus according to the conventional technology 2 is explained below. FIG. 33 is a schematic diagram for explaining an example of a configuration of the voice-band extending apparatus according to the conventional technology 2. As depicted in FIG. 33, a voice-band extending apparatus 10 includes an extension-signal creating unit 11, an SNR calculating unit 12, and a weight addition unit 13. The extension-signal creating unit 11 creates an extension signal by using a signal of an adjacent band among input signals that are input. The SNR calculating unit 12 calculates an SNR of the adjacent band. The weight addition unit 13 adds the extension signal to the input signal, and creates an output signal extended from the band of the input signal. Moreover, when the SNR of an adjacent band is low, the weight addition unit 13 attenuates the level of the whole of the extension signal such that a noise level included in the extension signal falls below a predetermined value, and then adds the extension signal to the input signal.
Patent Document 1: Japanese Laid-open Patent Publication No. 8-130494
Patent Document 2: Japanese Laid-open Patent Publication No. 2008-176328

However, the conventional technologies have a problem that when a lot of noises are included in an input signal, the sound quality cannot be surely improved even by extending the band. For example, according to the conventional technology 1, when a lot of noises are included in an input signal, an extension signal also includes a lot of noises, consequently, the sound quality cannot be improved. Moreover, according to the conventional technology 2, to suppress influence of noise, the level of the whole of an extension signal is attenuated, consequently, the level of a lost signal is not sufficiently compensated, and the sound quality cannot be improved.

### SUMMARY

According to an aspect of an embodiment of the invention, a voice-band extending apparatus includes an evaluating unit that evaluates one of a noise level and a signal noise ratio with respect to each of bands in an input signal that is input from an outside; a band selecting unit that selects a band that includes few noises from the input signal based on an evaluation result by the evaluating unit; a creating unit that creates an extension signal to extend a band in an input signal by using a signal of the band selected by the band selecting unit; and an addition unit that adds the extension signal created by the creating unit to the input signal.

According to another aspect of an embodiment of the invention, a voice-band extending method to be executed by a computer, the voice-band extending method includes evaluating one of a noise level and a signal noise ratio with respect to each of bands in an input signal that is input from an outside; selecting a band that includes few noises from the input signal based on an evaluation result by processing of the evaluating of the noise level; creating an extension signal to extend a band in an input signal by using a signal of the band selected by processing of the selecting of a band; and adding the extension signal created by processing of the creating of the extension signal to the input signal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram that depicts a configuration of a voice-band extending apparatus according to a first embodiment of the present invention;

FIG. 2 is a schematic diagram that depicts a configuration of a signal noise ratio (SNR) calculation processing unit depicted in FIG. 1;

FIG. 3 is a schematic diagram (1) that depicts respective SNRs of bands;

FIG. 4 is a schematic diagram that depicts relation between frequency BIN and magnitude of application gain;

FIG. 5 is a schematic diagram (1) for explaining extension-signal creating processing executed by an extension-signal creating unit;

FIG. 6 is a schematic diagram that depicts relation between frequency BIN and adjustment gain;

FIG. 7 is a schematic diagram for explaining level adjustment processing executed by the extension-signal creating unit;

FIG. 8 is a flowchart that depicts a process procedure performed by the voice-band extending apparatus according to the first embodiment;

FIG. 9 is a schematic diagram for explaining an effect of the voice-band extending apparatus according to the first embodiment;

FIG. 10 is a schematic diagram for explaining an effect of the voice-band extending apparatus according to the first embodiment;

FIG. 11 is a schematic diagram (2) that depicts respective SNRs of bands;

FIG. 12 is a schematic diagram that depicts a configuration of a voice-band extending apparatus according to a second embodiment of the present invention;

FIG. 13 is a schematic diagram (3) that depicts respective SNRs of bands;

FIG. 14 is a flowchart that depicts a process procedure performed by the voice-band extending apparatus according to the second embodiment;

FIG. 15 is a schematic diagram that depicts a configuration of a voice-band extending apparatus according to a third embodiment of the present invention;

FIG. 16 is a schematic diagram (4) that depicts respective SNRs of bands;

FIG. 17 is a schematic diagram (5) that depicts respective SNRs of bands;

FIG. 18 is a schematic diagram (2) for explaining extension-signal creating processing executed by the extension-signal creating unit;

FIG. 19 is a flowchart that depicts a process procedure performed by the voice-band extending apparatus according to the third embodiment;

FIG. 20 is a schematic diagram that depicts a configuration of a voice-band extending apparatus according to a fourth embodiment of the present invention;

FIG. 21 is a schematic diagram (6) that depicts respective SNRs of bands;

FIG. 22 is a schematic diagram (7) that depicts respective SNRs of bands;

FIG. 23 is a flowchart that depicts a process procedure performed by the voice-band extending apparatus according to the fourth embodiment;

FIG. 24 is a schematic diagram for explaining an effect of the voice-band extending apparatus according to the fourth embodiment;

FIG. 25 is a schematic diagram for explaining an effect of the voice-band extending apparatus according to the fourth embodiment;

FIG. 26 is a schematic diagram for explaining a conventional technology 1;

FIG. 27 is a schematic diagram for explaining the conventional technology 1;

FIG. 28 is a schematic diagram for explaining the conventional technology 1;

FIG. 29 is a schematic diagram for explaining a conventional technology 2;

FIG. 30 is a schematic diagram for explaining the conventional technology 2;

FIG. 31 is a schematic diagram for explaining the conventional technology 2;

FIG. 32 is a schematic diagram for explaining the conventional technology 2; and

FIG. 33 is a schematic diagram for explaining an example of a configuration of a voice-band extending apparatus according to the conventional technology 2.

### DESCRIPTION OF EMBODIMENTS

Preferred embodiments of the present invention will be explained with reference to accompanying drawings. However, the present invention is not limited by the embodiments. Each embodiment can be appropriately combined within a scope in which processing details do not contradict each other.

### [a] First Embodiment

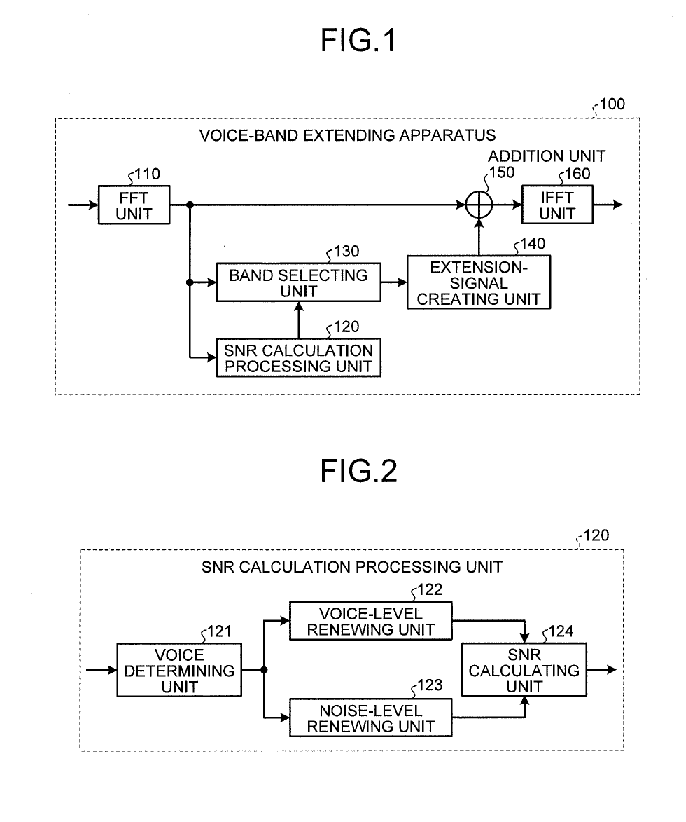

An example of a configuration of a voice-band extending apparatus according to a first embodiment of the present invention is explained below. FIG. 1 is a schematic diagram that depicts a configuration of the voice-band extending apparatus according to the first embodiment. As depicted in FIG. 1, a voice-band extending apparatus 100 includes a fast Fourier transform (FFT) unit 110, a signal noise ratio (SNR) calculation processing unit 120, a band selecting unit 130, an extension-signal creating unit 140, an addition unit 150, and an inverse fast Fourier transform (IFFT) unit 160.

The FFT unit 110 performs the Fourier transform on an input signal that is input from the outside, and outputs the Fourier-transformed input signal to the SNR calculation processing unit 120, the band selecting unit 130, and the addition unit 150. The input signal to be input into the FFT unit 110 is, for example, a narrow-band signal from zero to four kilohertz.

The FFT unit 110 calculates a spectrum Fᵢₙ(j) with respect to each frame of the input signal based on Expression (1) described below. In Expression (1), n denotes a frame number, xₙ denotes an input signal in the n-th frame, N denotes the length of FFT analysis, and j denotes the frequency BIN. In this case, assume that frequency BIN 0 to 192 correspond to frequencies zero hertz to six hertz, respectively.

$${F}_{in} ( j ) = {\sum }_{n = 0}^{N - 1} {x}_{n} {e}^{- \frac{2 π i}{N} j n} \qquad ( 1 )$$

The SNR calculation processing unit 120 calculates an SNR with respect to each of bands in an input signal, and outputs the calculated SNR of each band to the band selecting unit 130. In this case, assume that the SNR calculation processing unit 120 calculates each SNR by a bandwidth of two-kilohertz in the input signal. The SNR calculation processing unit 120 outputs the SNR of each band to the band selecting unit 130. The SNR calculation processing unit 120 is an example of an evaluating unit. Moreover, the SNR calculated by the SNR calculation processing unit 120 is an example of a noise level or a signal noise ratio.

A configuration of the SNR calculation processing unit 120 is explained below. FIG. 2 is a schematic diagram that depicts a configuration of the SNR calculation processing unit. As depicted in FIG. 2, the SNR calculation processing unit 120 includes a voice determining unit 121, a voice-level renewing unit 122, a noise-level renewing unit 123, and an SNR calculating unit 124.

The voice determining unit 121 determines voice/non-voice with respect to each frame of an input signal. For example, similarly to a technology as disclosed in Japanese Patent No. 3849116, the voice determining unit 121 calculates a feature amount by using a peak frequency and a pitch cycle of a power spectrum, and determines voice/non-voice based on whether the calculated feature amount is typical of voice.

In other words, when the feature amount of a frame of the input signal is typical of voice, the voice determining unit 121 determines that the frame is voice. In contrast, when the feature amount of a frame of the input signal is not typical of voice, the voice determining unit 121 determines that the frame is non-voice. Assume that the voice determining unit 121 preliminarily stores a feature amount that is typical of voice. The voice determining unit 121 outputs the frame determined as voice to the voice-level renewing unit 122, and outputs the frame determined as non-voice to the noise-level renewing unit 123.

The voice-level renewing unit 122 calculates a voice level with respect to each of bands in a frame, and outputs the calculated voice level to the SNR calculating unit 124. For example, the voice-level renewing unit 122 calculates a voice level V(n, Bᵢ) of each band by using Expression (2) described below. In Expression (2), n denotes a frame number, and Bᵢ denotes the i-th band. Moreover, spec_pow(n, Bᵢ) denotes an average of spectrum power of the i-th band, and COF1 denotes a smoothing coefficient. Assume that the voice-level renewing unit 122 has stored a voice level V(n−1, Bᵢ) calculated with respect to the previous frame.

V(n,Bᵢ)=V(n−1,Bᵢ)*COF1+spec_pow(n,Bᵢ)*(1.0−COF1) (2)

The noise-level renewing unit 123 calculates a noise level with respect to each of bands in a frame, and outputs the calculated noise level to the SNR calculating unit 124. For example, the noise-level renewing unit 123 calculates a noise level N(n, Bᵢ) of each band by using Expression (3) described below. COF2 in Expression (3) denotes a smoothing coefficient. Assume that the noise-level renewing unit 123 has stored a noise level N(n−1, Bᵢ) calculated with respect to the previous frame.

N(n,Bᵢ)=N(n−1,Bᵢ)*COF2+spec_pow(n,Bᵢ)*(1.0−COF2) (3)

The SNR calculating unit 124 calculates an SNR with respect to each band, and outputs the calculated SNR of each band to the band selecting unit 130. For example, the SNR calculating unit 124 calculates SNR(n, Bᵢ) from the voice level V(n, Bᵢ) and the noise level N(n, Bᵢ) by using Expression (4) described below.

$$SNR ( n , {B}_{i} ) = 10 log ( \frac{V ( n , {B}_{i} )}{N ( n , {B}_{i} )} ) \qquad ( 4 )$$

Return to the explanation of FIG. 1. The band selecting unit 130 selects a band of which SNR exceeds a threshold and is the maximum SNR, based on respective SNRs of the bands. The band selecting unit 130 then outputs a signal of the selected band to the extension-signal creating unit 140. The threshold is an arbitrary value that is set not to select a band with a low SNR. Moreover, the band selecting unit 130 is an example of a band selecting unit.

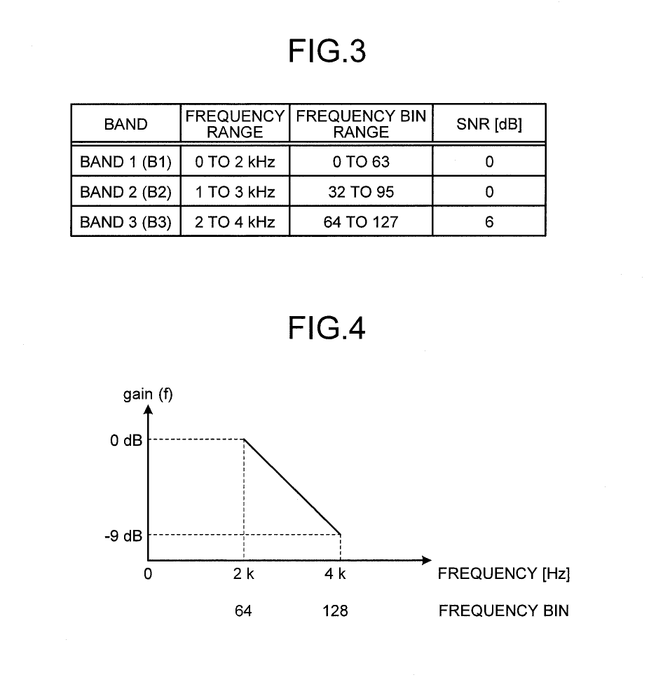

Processing to be performed by the band selecting unit 130 is specifically explained below. FIG. 3 is a schematic diagram that depicts respective SNRs of bands. According to the example depicted in FIG. 3, the SNR of a band 1 is zero decibel, the SNR of a band 2 is zero decibel, and the SNR of a band 3 is six decibels. In this case, assume that the band 1 is from zero to two kilohertz, the band 2 is from one to three kilohertz, and the band 3 is from two to four kilohertz. Moreover, assume that the frequency BIN range of the band 1 is from 0 to 63, the frequency BIN range of the band 2 is from 32 to 95, and the frequency BIN range of the band 3 is from 64 to 127.

Assuming that a threshold is set to “five”, a band of which SNR exceeds the threshold and is the maximum SNR is the band 3. Therefore, the band selecting unit 130 selects the band 3, and outputs a signal of the band 3 to the extension-signal creating unit 140. When the input signal includes no band of which SNR exceeds the threshold, the band selecting unit 130 outputs a signal of a level zero to the extension-signal creating unit 140. The threshold is not limited by this exemplification, and can be set to an arbitrary value by a user who uses the voice-band extending apparatus 100.

The extension-signal creating unit 140 creates an extension signal based on a signal acquired from the band selecting unit 130. The extension signal is a signal that compensates a treble component of the input signal. The extension-signal creating unit 140 outputs the created extension signal to the addition unit 150. The extension-signal creating unit 140 is an example of a creating unit.

Processing of creating an extension signal by the extension-signal creating unit 140 is explained below. The extension-signal creating unit 140 creates an attenuation signal by applying a gain to a signal acquired from the band selecting unit 130, and creates an extension signal by sifting the attenuation signal to an arbitrary frequency. In the following explanations, a signal acquired from the band selecting unit 130 is referred to as a selection signal, and a gain to be applied to the selection signal is referred to as an application gain.

The extension-signal creating unit 140 obtains an extension signal in accordance with Expression (5) described below. In Expression (5), j denotes a frequency BIN, and shift denotes a frequency shift amount. Moreover, Fₑₓ(j) denotes a spectrum of an extension signal corresponding to a frequency BIN “j”, and Fᵢₙ(j) denotes a spectrum of a selection signal corresponding to the frequency BIN “j”.

Fₑₓ(j+shift)=gain(j)*Fᵢₙ(j) (5)

Moreover, in Expression (5), gain(j) denotes an application gain. FIG. 4 is a schematic diagram that depicts relation between frequency BIN and magnitude of application gain. As depicted in FIG. 4, as the frequency BIN is getting larger, the magnitude of the application gain is getting smaller. According to the example depicted in FIG. 4, when the frequency BIN changes from 64 to 128, the magnitude of the application gain changes from 0 decibel to −9 decibels. In this way, by using a value with which relation between frequency and application gain goes downward rightwardly, an extension signal that typically represents characteristics of voice can be created. The reason for this is because a voice signal has a characteristic that the higher treble, the smaller the voice level is.

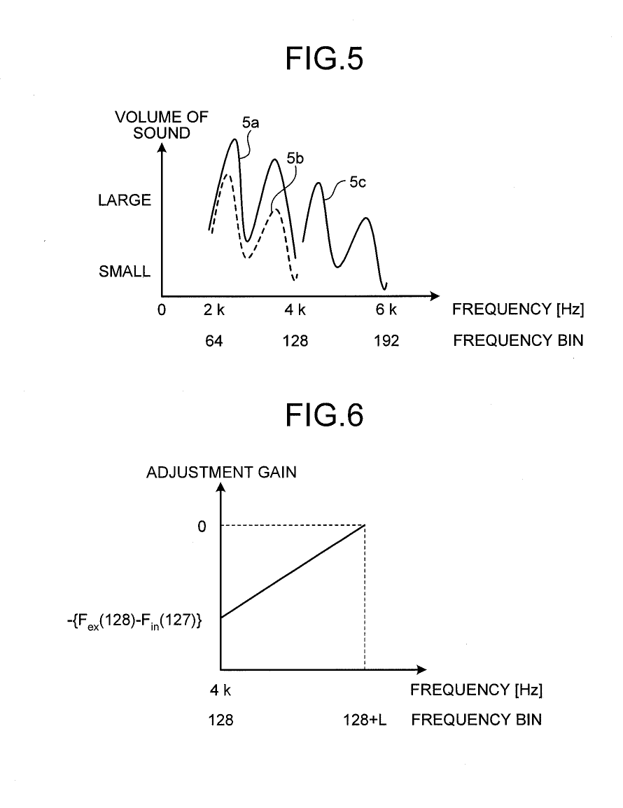

Processing of creating an attenuation signal from a selection signal, and creating an extension signal by the extension-signal creating unit 140 is explained below with reference to the drawings. FIG. 5 is a schematic diagram (1) for explaining extension-signal creating processing executed by the extension-signal creating unit. The horizontal axis in FIG. 5 represents the frequency and the frequency BIN, and the vertical axis represents the volume of sound. As an example, explained below is a case of creating an extension signal 5c from four to six kilohertz from a selection signal 5a from two to four kilohertz selected by the band selecting unit 130.

As depicted in FIG. 5, the extension-signal creating unit 140 attenuates the selection signal 5a by applying an application gain to the selection signal 5a, thereby creating an attenuation signal 5b. The extension-signal creating unit 140 then shifts the attenuation signal 5b by two kilohertz to the treble side, thereby creating the extension signal 5c.

Although according to the example depicted in FIG. 4, explained above is an application gain to be applied when a band selected by the band selecting unit 130 is from two to four kilohertz, the present invention is not limited to this. In other words, the value of the application gain gain(j) can be changed in accordance with a band selected by the band selecting unit 130. For example, when a band selected by the band selecting unit 130 is from zero to two kilohertz, the value of the application gain gain(j) can be smaller to attenuate to a larger extent.

When a level difference between signals at a border frequency between an input signal and an extension signal, if a treble component of the input signal is compensated by directly using the extension signal, spectra become discontinuous, consequently the sound quality is degraded. For this reason, when a level difference between signals at a border frequency between an input signal and an extension signal, the extension-signal creating unit 140 increases or decreases the level of the extension signal, and eliminates discontinuity of spectra at the border frequency, thereby avoiding degrading the sound quality.

Processing of adjusting the level of an extension signal by the extension-signal creating unit 140 is specifically explained below. As an example, assume that a border frequency between the input signal and the extension signal is four kilohertz. Assume that a frequency BIN corresponding to the frequency of four kilohertz is 128. The extension-signal creating unit 140 adjusts the extension signal in accordance with Expression (6). In Expression (6), Fₑₓ′(j) denotes a spectrum of the adjusted extension signal corresponding to a frequency BIN “j”. Fₑₓ(j) denotes a spectrum of the extension signal before adjusted corresponding to the frequency BIN “j”. Fᵢₙ(127) denotes a spectrum of the input signal corresponding to a frequency BIN “127”. Fₑₓ(128) denotes a spectrum of the extension signal before adjusted corresponding to a frequency BIN “128”.

$${F}_{ex}^{′} ( j ) = {F}_{ex} ( j ) - \{ {F}_{ex} ( 128 ) - {F}_{in} ( 127 ) \} * \frac{128 + L - j}{L} \qquad ( 6 )$$

Moreover, in Expression (6), −{Fₑₓ(128)−Fᵢₙ(127)}×(128+L−j)/L expresses an adjustment gain for adjusting the extension signal. The extension-signal creating unit 140 applies the adjustment gain to the extension signal in the frequency BIN range j=128 to 128+L, thereby adjusting the extension signal. L corresponds to the frequency BIN range in which a level adjustment is performed.

FIG. 6 is a schematic diagram that depicts relation between frequency BIN and adjustment gain. The horizontal axis in FIG. 6 represents the frequency and the frequency BIN, and the vertical axis represents the magnitude of the adjustment gain. As depicted in FIG. 6, the extension-signal creating unit 140 sets an adjustment gain to be added at j=128 to −{Fₑₓ(128)−Fᵢₙ(127)}, and changes the adjustment gain in accordance with the frequency BIN such that an adjustment gain to be added at j=128+L is to be zero.

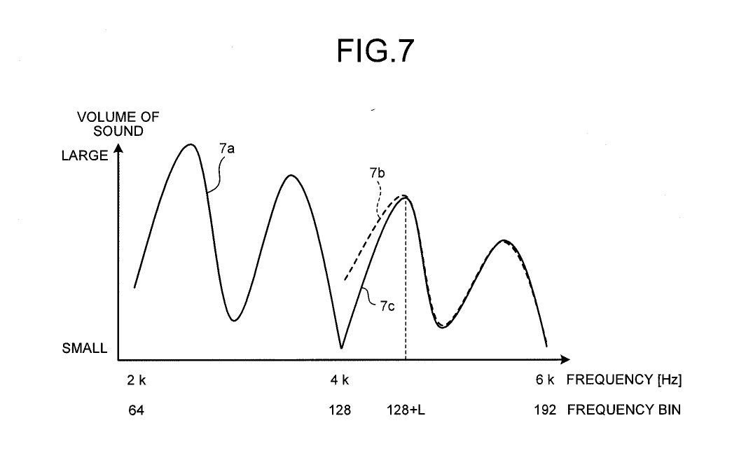

Processing of adjusting an extension signal by the extension-signal creating unit 140 is explained below with reference to the drawings. FIG. 7 is a schematic diagram for explaining level adjustment processing executed by the extension-signal creating unit. The horizontal axis in FIG. 7 represents the frequency and the frequency BIN, and the vertical axis represents the volume of sound. A signal 7a in FIG. 7 denotes an input signal, a signal 7b denotes an extension signal, and a signal 7c denotes an extension signal after level adjustment. As depicted in FIG. 7, as the extension-signal creating unit 140 applies the adjustment gain, and adjusts the extension signal 7b to the extension signal 7c, so that spectra of the input signal 7a and the extension signal 7c become continuous, thereby avoiding sound-quality degradation.

Return to the explanation of FIG. 1. The addition unit 150 adds an extension signal to an input signal, and creates a band-extended signal. The band-extended signal created by the addition unit 150 is, for example, a signal from zero to six kilohertz. The addition unit 150 outputs the created band-extended signal to the IFFT unit 160. The addition unit 150 is an example of an addition unit.

For example, the addition unit 150 adds the extension signal to the input signal by using Expression (7) described below. Fₒᵤₜ(j) in FIG. 7 denotes a spectrum of the band-extended signal, Fᵢₙ(j) denotes a spectrum of the input signal, and Fₑₓ(j) denotes a spectrum of the extension signal.

Fₒᵤₜ(j)=Fᵢₙ(j)+Fₑₓ(j) (7)

The IFFT unit 160 performs the inverse fast Fourier transform on a band-extended signal, and creates an output signal. For example, the IFFT unit 160 creates an output signal xₙ by using Expression (8) described below. The IFFT unit 160 outputs the created output signal to the outside.

$${X}_{n} = \frac{1}{N} {\sum }_{j = 0}^{N - 1} {F}_{in} ( j ) {e}^{\frac{2 π i}{N} j n} \qquad ( 8 )$$

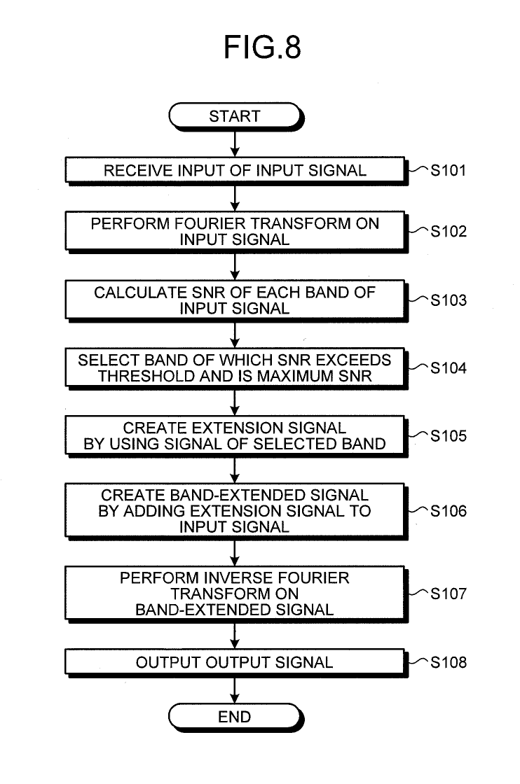

An example of a process procedure performed by the voice-band extending apparatus according to the first embodiment is explained below. FIG. 8 is a flowchart that depicts the process procedure performed by the voice-band extending apparatus according to the first embodiment. The processing depicted in FIG. 8 is to be executed, for example, upon receiving input of an input signal into the voice-band extending apparatus 100.

As depicted in FIG. 8, when an input signal is input into the voice-band extending apparatus 100 (Step S101); the voice-band extending apparatus 100 performs the Fourier transform on the input signal (Step S102). The voice-band extending apparatus 100 calculates an SNR with respect to each of bands in the input signal (Step S103).

The voice-band extending apparatus 100 selects a band of which SNR exceeds the threshold and is the maximum SNR, based on respective SNRs of the bands (Step S104). The voice-band extending apparatus 100 creates an extension signal based on a signal of the selected band (Step S105); adds the created extension signal to the input signal, thereby creating a band-extended signal (Step S106).

The voice-band extending apparatus 100 performs the inverse Fourier transform on the band-extended signal (Step S107); and outputs the inverse-Fourier-transformed band-extended signal as an output signal (Step S108).

Effects of the voice-band extending apparatus according to the first embodiment are explained below. The voice-band extending apparatus 100 according to the first embodiment calculates an SNR with respect to each of bands in an input signal that is input, and selects a band of which SNR exceeds a threshold and is the maximum SNR based on respective SNRs of the bands. The voice-band extending apparatus 100 creates an extension signal by using a signal of the selected band, thereby extending the input signal. In other words, because the voice-band extending apparatus 100 creates and extension signal by using a signal of a band with few noises in the input signal, thereby suppressing noises included in the extension signal to a low level, so that the sound quality can be improved.

Moreover, the voice-band extending apparatus 100 changes an application gain in accordance with the frequency of a selected band even if selecting any of the bands in the input signal, thereby being capable to create an extension signal that is appropriately attenuated so as to represent characteristics of voice typically, so that the sound quality can be improved.

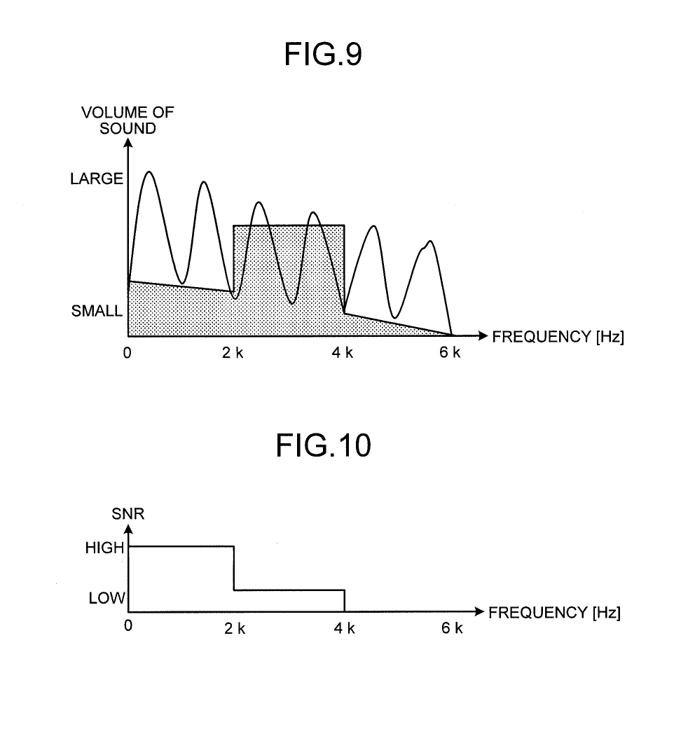

FIGS. 9 and 10 are schematic diagrams for explaining effects of the voice-band extending apparatus according to the first embodiment. The horizontal axis in FIG. 9 represents the frequency, and the vertical axis represents the volume of sound. A shadow part in FIG. 9 indicates the level of noises included in a voice signal. FIG. 10 depicts the level of SNR corresponding to FIG. 9. As an example, explained below is a case of extending a band from four to six kilohertz by using a signal of a band from zero to two kilohertz. Assume that the SNR of the band from zero to two kilohertz depicted in FIG. 10 exceeds the threshold.

As depicted in FIGS. 9 and 10, the voice-band extending apparatus 100 selects the band from zero to two kilohertz as a band of which SNR exceeds the threshold and is the maximum SNR. The voice-band extending apparatus 100 creates an extension signal from four to six kilohertz by using a signal of the selected band, and extends the input signal, thereby achieving an effect of great improvement in the sound quality while suppressing influence of noise.

According to the conventional technologies, because an extension signal is created and added to the input signal even when the SNR of a band to be used for creating the extension signal is low, the sound quality is degraded adversely. By contrast, when the input signal includes no band of which SNR exceeds the threshold, the voice-band extending apparatus 100 adds a signal of the level 0 instead of an extension signal to the input signal. For this reason, the voice-band extending apparatus 100 is configured not to add an extension signal created based on a signal of which SNR is lower than the threshold, thereby being capable to avoid degradation of the sound quality.

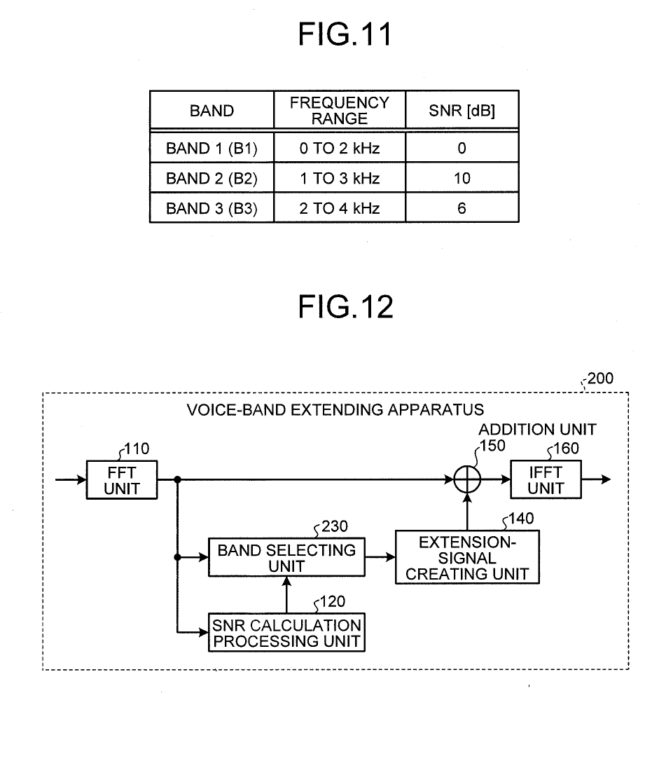

Although according to the example depicted in FIG. 3, explained above is a case where there is only one band of which SNR exceeds the threshold, if there is a plurality of bands of which SNR exceeds the threshold, the band selecting unit 130 selects a band that has the maximum SNR. FIG. 11 is a schematic diagram (2) that depicts respective SNRs of bands.

According to an example depicted in FIG. 11, the SNR of the band 1 is zero decibel, the SNR of the band 2 is 10 decibels, and the SNR of the band 3 is six decibels. In this case, assume that the band 1 is from zero to two kilohertz, the band 2 is from one to three kilohertz, and the band 3 is from two to four kilohertz.

Assuming that a threshold is set to “five”, bands of which SNRs exceed the threshold are the band 2 and the band 3. Among them, a band of which SNR is the maximum is the band 2. Therefore, the band selecting unit 130 selects the band 2. The threshold is not limited by this exemplification, and can be set to an arbitrary value by a user who uses the voice-band extending apparatus 100.

### [b] Second Embodiment

An example of a configuration of a voice-band extending apparatus according to a second embodiment of the present invention is explained below. FIG. 12 is a schematic diagram that depicts a configuration of the voice-band extending apparatus according to the second embodiment. As depicted in FIG. 12, a voice-band extending apparatus 200 includes the FFT unit 110, the SNR calculation processing unit 120, a band selecting unit 230, the extension-signal creating unit 140, the addition unit 150, and the IFFT unit 160. Among them, explanations of the FFT unit 110 and the SNR calculation processing unit 120 depicted in FIG. 10 are similar to explanations of the FFT unit 110 and the SNR calculation processing unit 120 depicted in FIG. 1. Moreover, explanations of the extension-signal creating unit 140, the addition unit 150, and the IFFT unit 160 depicted in 12 are similar to explanations of the extension-signal creating unit 140, the addition unit 150, and the IFFT unit 160 depicted in FIG. 1.

The band selecting unit 230 selects a band that has an SNR exceeding a threshold and is closest to a band to be extended, based on respective SNRs of bands. The band selecting unit 230 then outputs a signal of the selected band to the extension-signal creating unit 140. The threshold is an arbitrary value that is set not to select a band with a low SNR. Moreover, the band selecting unit 230 is an example of the band selecting unit.

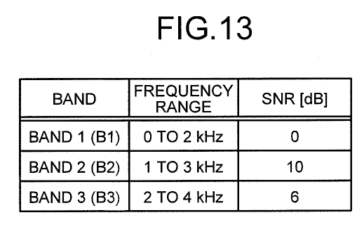

Processing to be performed by the band selecting unit 230 is specifically explained below. FIG. 13 is a schematic diagram (3) that depicts respective SNRs of bands. According to an example depicted in FIG. 13, the SNR of the band 1 is zero decibel, the SNR of the band 2 is 10 decibels, and the SNR of the band 3 is six decibels. In this case, assume that the band 1 is from zero to two kilohertz, the band 2 is from one to three kilohertz, and the band 3 is from two to four kilohertz.

Assuming that a threshold is set to “five”, bands of which SNRs exceed the threshold are the band 2 and the band 3. Moreover, assuming that the band to be extended is from four to six kilohertz, the band closest to the band to be extended is the band 3. Therefore, the band selecting unit 230 selects the band 3, and outputs a signal of the band 3 to the extension-signal creating unit 140. When the input signal includes no band of which SNR exceeds the threshold, the band selecting unit 230 outputs a signal of the level zero to the extension-signal creating unit 140. The threshold is not limited by this exemplification, and can be set to an arbitrary value by a user who uses the voice-band extending apparatus 200.

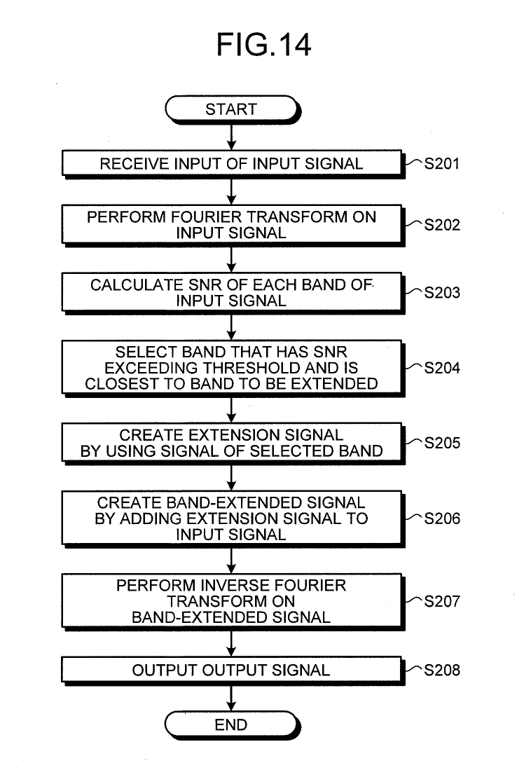

An example of a process procedure performed by the voice-band extending apparatus according to the second embodiment is explained below. FIG. 14 is a flowchart that depicts a process procedure performed by the voice-band extending apparatus according to the second embodiment. The processing depicted in FIG. 14 is to be executed, for example, upon receiving input of an input signal into the voice-band extending apparatus 200.

As depicted in FIG. 14, when an input signal is input into the voice-band extending apparatus 200 (Step S201); the voice-band extending apparatus 200 performs the Fourier transform on the input signal (Step S202). The voice-band extending apparatus 200 calculates an SNR with respect to each of bands in the input signal (Step S203).

The voice-band extending apparatus 200 selects a band that has an SNR exceeding a threshold and is closest to a band to be extended, based on respective SNRs of the bands (Step S204). The voice-band extending apparatus 200 creates an extension signal by using a signal of the selected band (Step S205); and adds the created extension signal to the input signal, thereby creating a band-extended signal (Step S206).

The voice-band extending apparatus 200 performs the inverse Fourier transform on the band-extended signal (Step S207); and outputs the inverse-Fourier-transformed band-extended signal as an output signal (Step S208).

Effects of the voice-band extending apparatus according to the second embodiment are explained below. The voice-band extending apparatus 200 according to the second embodiment calculates an SNR with respect to each of bands in an input signal that is input, and selects a band that has an SNR exceeding a threshold and has a waveform closest to the waveform of a band to be extended, based on respective SNRs of the bands. The voice-band extending apparatus 200 creates an extension signal by using a signal of the selected band, thereby extending the input signal. In other words, the voice-band extending apparatus 200 creates an extension signal by using a signal that has few noises and is close to the signal waveform of a band to be extended in the input signal, thereby being capable to create an extension signal closer to a treble signal waveform, so that the sound quality can be improved.

### [c] Third Embodiment

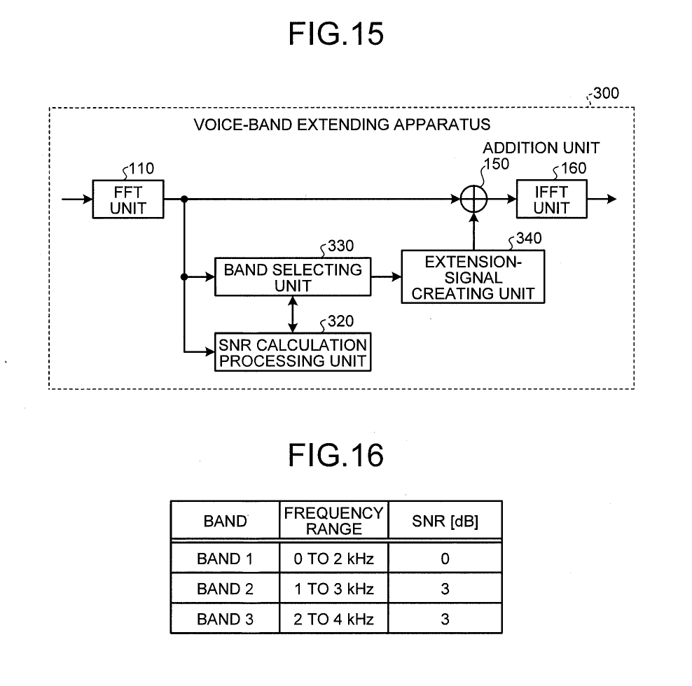

An example of a configuration of a voice-band extending apparatus according to a third embodiment of the present invention is explained below. FIG. 15 is a schematic diagram that depicts a configuration of the voice-band extending apparatus according to the third embodiment. As depicted in FIG. 15, a voice-band extending apparatus 300 includes the FFT unit 110, an SNR calculation processing unit 320, a band selecting unit 330, an extension-signal creating unit 340, the addition unit 150, and the IFFT unit 160. Among them, explanations of the FFT unit 110, the addition unit 150, and the IFFT unit 160 depicted in FIG. 15 are similar to explanations of the FFT unit 110, the addition unit 150, and the IFFT unit 160 depicted in FIG. 1.

The SNR calculation processing unit 320 has the same function as that of the SNR calculation processing unit 120. Furthermore, the SNR calculation processing unit 320 receives a command to recalculate SNRs by a bandwidth set by the band selecting unit 330 described later. The SNR calculation processing unit 320 then recalculates SNRs based on the command received from the band selecting unit 330, and outputs the recalculated SNRs of the respective bands to the band selecting unit 330. The SNR calculation processing unit 320 is an example of the evaluating unit.

For example, the SNR calculation processing unit 320 receives from the band selecting unit 330 a command to recalculate SNRs by a bandwidth of one kilohertz. The SNR calculation processing unit 320 then recalculates SNRs by a bandwidth of one kilohertz, and outputs the recalculated SNRs of the respective bands to the band selecting unit 330.

The band selecting unit 330 has the same function as that of the band selecting unit 130. Furthermore, when the input signal includes no band of which SNR exceeds the threshold, the band selecting unit 330 sets a bandwidth for calculating each SNR to a narrower bandwidth. The band selecting unit 330 outputs a command to recalculate SNRs by the set bandwidth to the SNR calculation processing unit 320. The band selecting unit 330 then selects a band of which SNR exceeds a threshold and is the maximum SNR, based on the recalculated SNRs, and outputs a signal of the selected band to the extension-signal creating unit 340. The threshold is an arbitrary value that is set not to select a band with a low SNR. Moreover, the band selecting unit 330 is an example of the band selecting unit.

Processing to be performed by the band selecting unit 330 is specifically explained below. FIG. 16 is a schematic diagram (4) that depicts respective SNRs of bands. According to FIG. 16, a case where each SNR is calculated by a bandwidth of two kilohertz is explained below. According to an example depicted in FIG. 16, the SNR of the band 1 is zero decibel, the SNR of the band 2 is three decibels, and the SNR of the band 3 is three decibels. In this case, assume that the band 1 is from zero to two kilohertz, the band 2 is from one to three kilohertz, and the band 3 is from two to four kilohertz.

Assuming that a threshold is set to “five”, there is no band of which SNR exceeds the threshold. For this reason, the band selecting unit 330 sets a bandwidth for calculating each SNR to one kilohertz, and outputs to the SNR calculation processing unit 320 a command to recalculate SNRs by the bandwidth of one kilohertz.

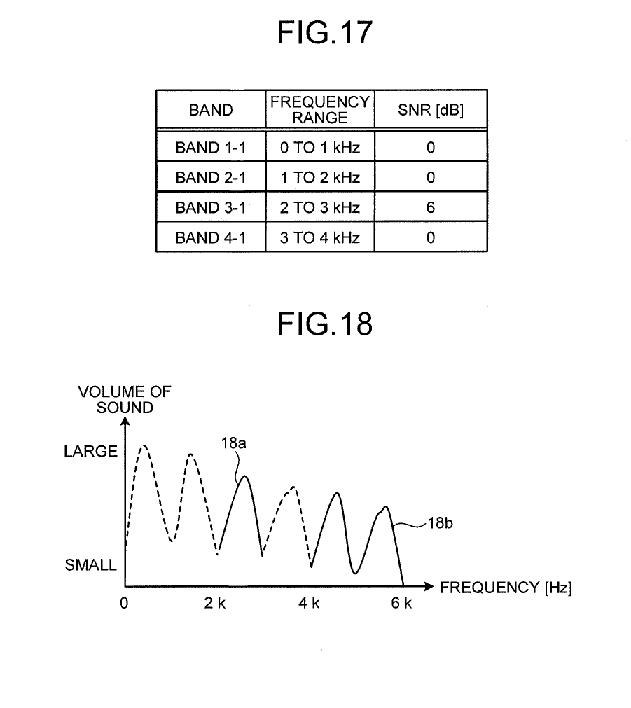

FIG. 17 is a schematic diagram (5) that depicts respective SNRs of bands. According to FIG. 17, a case where each SNR is calculated by a bandwidth of one kilohertz is explained below. According to an example depicted in FIG. 17, the SNR of the band 1-1 is zero decibel, the SNR of the band 2-1 is 0 decibel, the SNR of the band 3-1 is six decibels, and the SNR of the band 4-1 is zero decibel. In this case, assume that the band 1-1 is from zero to one kilohertz, the band 2-1 is from one to two kilohertz, the band 3-1 is from two to three kilohertz, and the band 4-1 is from three to four kilohertz.

When calculating SNRs by a bandwidth of one kilohertz, a band of which SNR exceeds the threshold “five” and is the maximum SNR is the band 3-1. For this reason, the band selecting unit 330 selects the band 3-1, and outputs a signal of the band 3-1 to the extension-signal creating unit 340. The threshold is not limited by this exemplification, and can be set to an arbitrary value by a user who uses the voice-band extending apparatus 300.

The extension-signal creating unit 340 has the same function as that of the extension-signal creating unit 140. Furthermore, when a band acquired from the band selecting unit 330 is narrower than a band to be extended, the extension-signal creating unit 340 creates a plurality of attenuation signals from a signal of the acquired band, and shifts the attenuation signals to respective different frequencies, thereby creating an extension signal. The extension-signal creating unit 340 is and example of the creating unit.

FIG. 18 is a schematic diagram (2) for explaining extension-signal creating processing executed by the extension-signal creating unit. The horizontal axis in FIG. 18 represents the frequency, and the vertical axis represents the volume of sound. As an example, explained below is a case of creating an extension signal 18b from four to six kilohertz from a selection signal 18a from two to three kilohertz selected by the band selecting unit 330.

As depicted in FIG. 18, the extension-signal creating unit 340 attenuates the selection signal 18a by applying an application gain to the selection signal 18a, and shifts it by two kilohertz to the treble side, thereby creating a signal from four to five kilohertz. Moreover, the extension-signal creating unit 340 attenuates the selection signal 18a by applying the application gain to the selection signal 18a, and shifts it by three kilohertz to the treble side, thereby creating a signal from five to six kilohertz. The extension-signal creating unit 340 then adds the signal from four to five kilohertz to the signal from five to six kilohertz, thereby creating the extension signal 18b from four to six kilohertz.

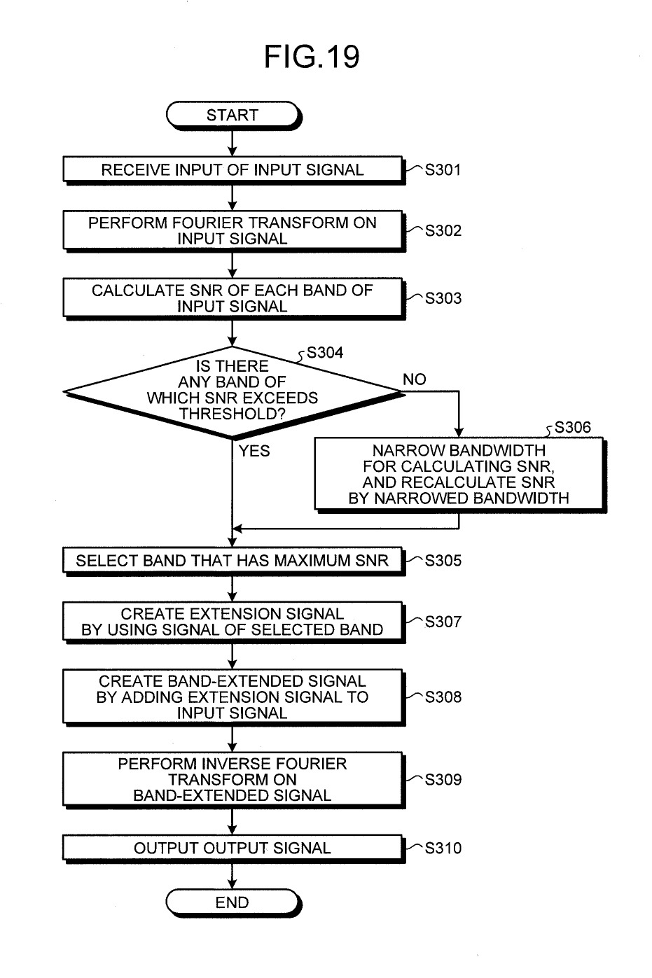

An example of a process procedure performed by the voice-band extending apparatus according to the third embodiment is explained below. FIG. 19 is a flowchart that depicts a process procedure performed by the voice-band extending apparatus according to the third embodiment. The processing depicted in FIG. 19 is to be executed, for example, upon receiving input of an input signal into the voice-band extending apparatus 300.

As depicted in FIG. 19, when an input signal is input into the voice-band extending apparatus 300 (Step S301); the voice-band extending apparatus 300 performs the Fourier transform on the input signal (Step S302). The voice-band extending apparatus 300 calculates an SNR with respect to each of bands in the input signal (Step S303).

If there is any band of which SNR exceeds the threshold (Yes at Step S304), the voice-band extending apparatus 300 selects a band that has the maximum SNR (Step S305). By contrast, if there is no band of which SNR exceeds the threshold (No at Step S304), the voice-band extending apparatus 300 narrows the bandwidth for calculating each SNR, and recalculates SNRs by the narrowed bandwidth (Step S306), and goes to Step S305.

The voice-band extending apparatus 300 creates an extension signal from a signal of the selected band (Step S307); and adds the created extension signal to the input signal, thereby creating a band-extended signal (Step S308).

The voice-band extending apparatus 300 performs the inverse Fourier transform on the band-extended signal (Step S309); and outputs the inverse-Fourier-transformed band-extended signal as an output signal (Step S310).

Effects of the voice-band extending apparatus according to the third embodiment are explained below. The voice-band extending apparatus 300 according to the third embodiment calculates an SNR with respect to each of bands in an input signal that is input, and selects a band of which SNR exceeds a threshold and is the maximum SNR, based on respective SNRs of the bands. Moreover, if there is no band of which SNR exceeds the threshold, the voice-band extending apparatus 300 narrows the bandwidth for calculating each SNR, recalculates SNRs by the narrowed bandwidth, thereby selecting a band based on the respective recalculated SNRs of the bands. In other words, even when a band with few noises cannot be detected with respect to a specific bandwidth from the input signal, the voice-band extending apparatus 300 detects a band with few noises and creates an extension signal by adjusting the bandwidth, so that the sound quality can be improved.

### [d] Fourth Embodiment

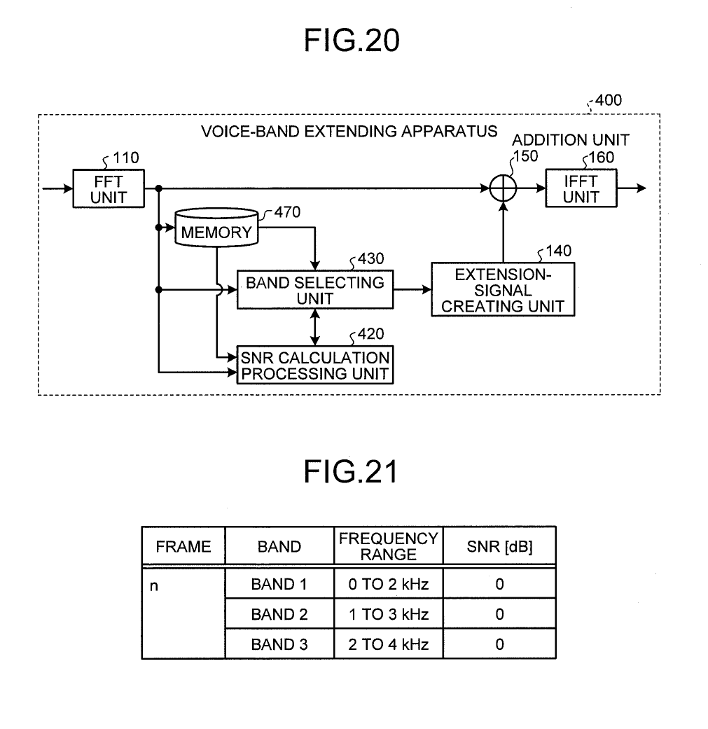

An example of a configuration of a voice-band extending apparatus according to a fourth embodiment of the present invention is explained below. FIG. 20 is a schematic diagram that depicts a configuration of the voice-band extending apparatus according to the fourth embodiment. As depicted in FIG. 20, a voice-band extending apparatus 400 includes the FFT unit 110, an SNR calculation processing unit 420, a band selecting unit 430, the extension-signal creating unit 140, the addition unit 150, the IFFT unit 160, and a memory 470. Among them, explanations of the FFT unit 110, the extension-signal creating unit 140, the addition unit 150, and the IFFT unit 160 depicted in FIG. 20 are similar to explanations of the FFT unit 110, the extension-signal creating unit 140, the addition unit 150, and the IFFT unit 160 depicted in FIG. 1.

The SNR calculation processing unit 420 has the same function as that of the SNR calculation processing unit 120. Furthermore, the SNR calculation processing unit 420 acquires a frame in the past of an input signal from the memory 470 described later, and recalculates respective SNRs of bands by using the past frame. The SNR calculation processing unit 420 is an example of the evaluating unit.

For example, assuming that a current frame is the n-th frame, the SNR calculation processing unit 420 acquires the (n−1)th frame from the memory 470, and calculates respective SNRs of bands by using the (n−1)th frame. The SNR calculation processing unit 420 then outputs the respective SNRs of the bands in the (n−1)th frame to the band selecting unit 430.

The band selecting unit 430 has the same function as that of the band selecting unit 130. Furthermore, when the input signal includes no band of which SNR exceeds the threshold, the band selecting unit 430 outputs to the SNR calculation processing unit 420 a command to recalculate respective SNRs of the bands by using a past frame of the input signal. The band selecting unit 430 selects a band that has an SNR exceeding a threshold and is of a frame closest to the current frame, based on the SNRs recalculated by the SNR calculation processing unit 420. The band selecting unit 430 then outputs a signal of the selected band to the extension-signal creating unit 140. The threshold is an arbitrary value that is set not to select a band with a low SNR. Moreover, the band selecting unit 430 is an example of the band selecting unit.

Processing to be performed by the band selecting unit 430 is specifically explained below. FIG. 21 is a schematic diagram (6) that depicts respective SNRs of the bands. According to an example depicted in FIG. 21, the SNR of the band 1 in the n-th frame is zero decibel, the SNR of the band 2 is zero decibel, and the SNR of the band 3 is zero decibel. In this case, assume that the band 1 is from zero to two kilohertz, the band 2 is from one to three kilohertz, and the band 3 is from two to four kilohertz. Moreover, assume that the n-th frame is the current frame.

Assuming that a threshold is set to “five”, there is no band of which SNR exceeds the threshold. For this reason, the band selecting unit 430 outputs to the SNR calculation processing unit 420 a command to recalculate SNRs by using the (n−1)th frame and the (n−2)th frame of the input signal. The band selecting unit 430 then acquires respective SNRs of the bands recalculated by the SNR calculation processing unit 420.

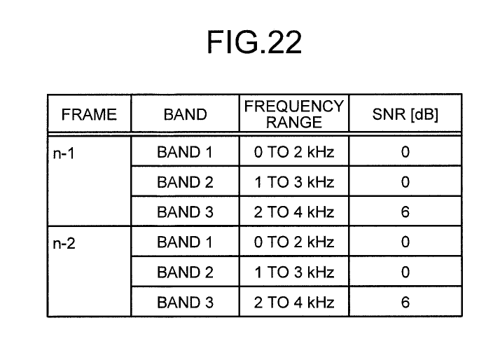

FIG. 22 is a schematic diagram (7) that depicts respective SNRs of the bands. According to an example depicted in FIG. 22, the SNR of the band 1 in the (n−1)th frame is zero decibel, the SNR of the band 2 is zero decibel, and the SNR of the band 3 is six decibels. Moreover, the SNR of the band 1 in the (n−2)th frame is zero decibel, the SNR of the band 2 is zero decibel, and the SNR of the band 3 is six decibels. In this case, assume that the band 1 is from zero to two kilohertz, the band 2 is from one to three kilohertz, and the band 3 is from two to four kilohertz. Moreover, assume that the (n−1)th frame is at one frame previous to the current frame, and the (n−2)th frame is at two frames previous to the current frame.

When recalculating SNRs by using the (n−1)th frame and the (n−2)th frame, a band of which SNR exceeds the threshold “five” is the band 3 in the (n−1)th frame, and the band 3 in the (n−2)th frame. Among them, a band of a frame closest to the current frame is the band 3 in the (n−1)th frame. For this reason, the band selecting unit 430 selects the band 3 in the (n−1)th frame, and outputs a signal of the band 3 in the (n−1)th frame to the extension-signal creating unit 140. The threshold is not limited by this exemplification, and can be set to an arbitrary value by a user who uses the voice-band extending apparatus 400.

The past frames used by the band selecting unit 430 are not limited to the (n−1)th frame and the (n−2)th frame, and a further previous frame can be used within a range in which the waveform of a voice signal does not change to a large extent. For example, assuming that one frame is equivalent to 256 samples, the waveform of a voice signal does not change substantially within approximately eight frames, therefore, the band selecting unit 430 can use frames up to the (n−7)th frame.

The memory 470 stores an input signal output from the FFT unit 110 with respect to each frame. For example, the memory 470 stores the n-th frame, the (n−1)th frame, and the (n−2)th frame of the input signal.

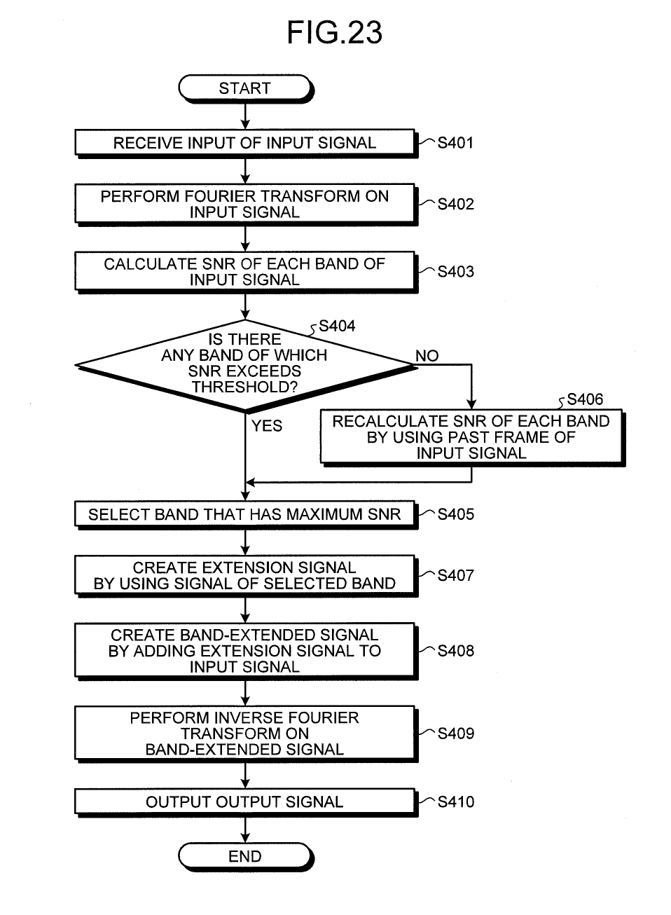

An example of a process procedure performed by the voice-band extending apparatus according to the fourth embodiment is explained below. FIG. 23 is a flowchart that depicts the process procedure performed by the voice-band extending apparatus according to the fourth embodiment. The processing depicted in FIG. 23 is to be executed, for example, upon receiving input of an input signal into the voice-band extending apparatus 400.

As depicted in FIG. 23, when an input signal is input into the voice-band extending apparatus 400 (Step S401); the voice-band extending apparatus 400 performs the Fourier transform on the input signal (Step S402). The voice-band extending apparatus 400 calculates an SNR with respect to each of bands in the input signal (Step S403).

If there is any band of which SNR exceeds the threshold (Yes at Step S404), the voice-band extending apparatus 400 selects a band that has the maximum SNR (Step S405). By contrast, if there is no band of which SNR exceeds the threshold (No at Step S404), the voice-band extending apparatus 400 recalculates respective SNRs of the bands by using a past frame of the input signal (Step S406), and goes to Step S405.

The voice-band extending apparatus 400 creates an extension signal from a signal of the selected band (Step S407); and adds the created extension signal to the input signal, thereby creating a band-extended signal (Step S408).

The voice-band extending apparatus 400 performs the inverse Fourier transform on the band-extended signal (Step S409); and outputs the inverse-Fourier-transformed band-extended signal as an output signal (Step S410).

Effects of the voice-band extending apparatus according to the fourth embodiment are explained below. The voice-band extending apparatus 400 according to the fourth embodiment calculates an SNR with respect to each of bands in an input signal that is input, and selects a band of which SNR exceeds a threshold and is the maximum SNR, based on respective SNRs of the bands. Moreover, if there is no band of which SNR exceeds the threshold, the voice-band extending apparatus 400 recalculates respective SNRs of the bands by using a past frame of the input signal, thereby selecting a band based on the respective recalculated SNRs of the bands. Therefore, even when the input signal includes no band with few noises, the voice-band extending apparatus 400 selects a band with few noises from a past input signal and creates an extension signal, thereby suppressing noises included in the extension signal to a low level, so that the sound quality can be improved.

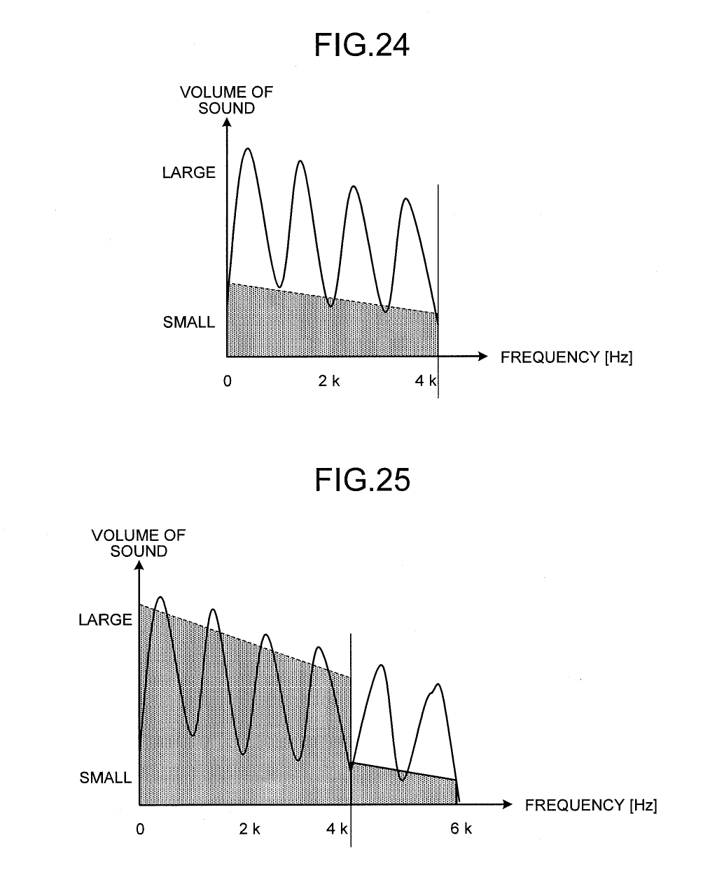

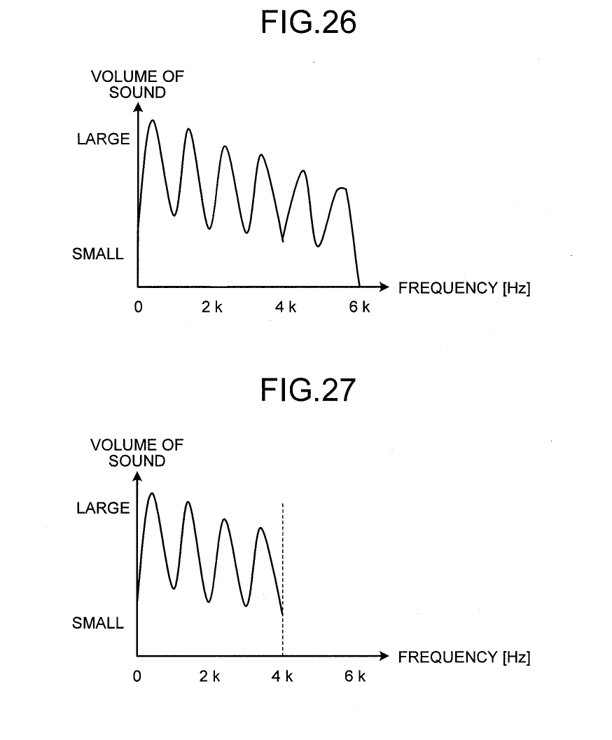

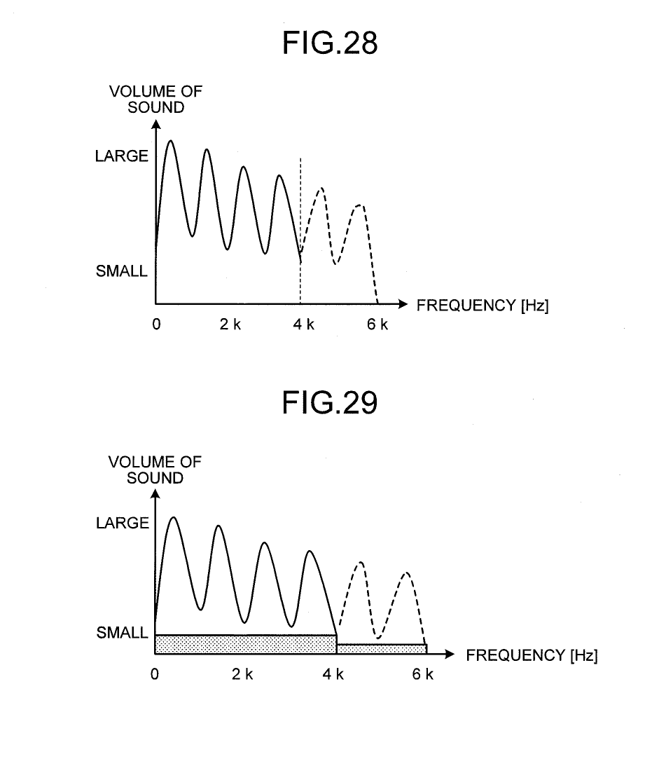

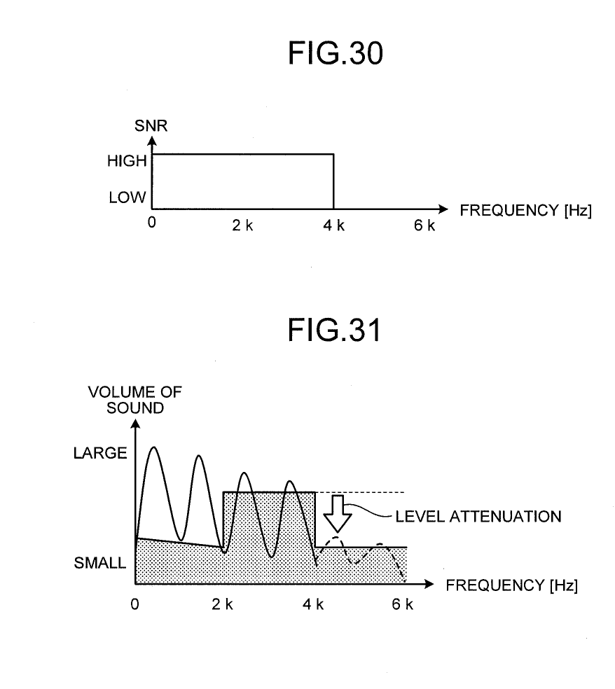

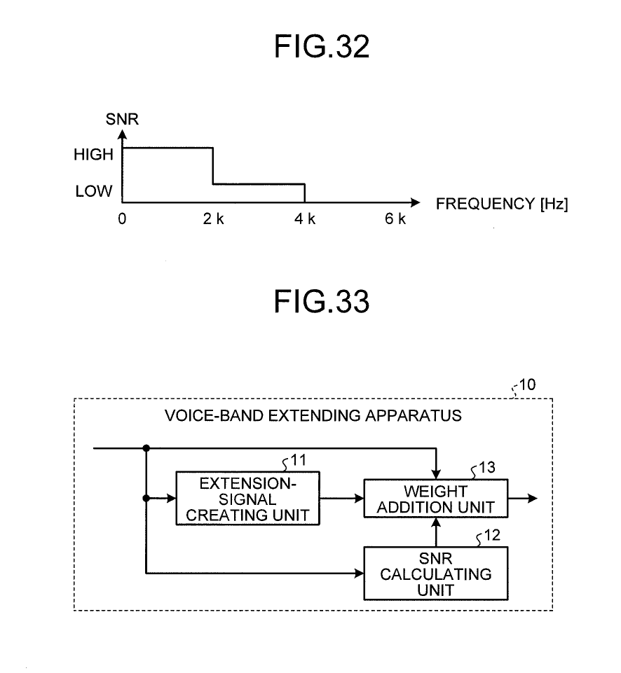

FIGS. 24 and 25 are schematic diagrams for explaining effects of the voice-band extending apparatus according to the fourth embodiment. The horizontal axis in FIGS. 24 to 25 represents the frequency, and the vertical axis represents the volume of sound. Shadow parts in FIGS. 24 and 35 indicate the level of noises included in voice signals. FIG. 24 depicts a current frame of the input signal, and FIG. 25 depicts a past frame of the input signal. As an example, explained below is a case of extending a band from four to six kilohertz by using a signal of a band from two to four kilohertz. Assume that the SNR of a band from zero to four kilohertz depicted in FIG. 24 does not exceed the threshold, and the SNR of a band from two to four kilohertz depicted in FIG. 25 exceeds the threshold and is the maximum SNR.

As depicted in FIGS. 24 and 25, when the current frame includes no band of which SNR exceeds the threshold, the voice-band extending apparatus 400 selects the band from two to four kilohertz in the past frame as a band of which SNR exceeds the threshold and is the maximum SNR. The voice-band extending apparatus 400 creates an extension signal from four to six kilohertz by using a signal of the selected band, and extends the input signal, thereby achieving an effect of great improvement in the sound quality while suppressing influence of noise.

Among various processings explained in the first to fourth embodiments, all or part of the processing configured to be automatically performed can be manually performed, or all or part of the processing configured to be manually performed can be automatically performed. In addition, the process procedures, the control procedures, the specific names, and information including various data and parameters described in the above description or depicted in the drawings can be arbitrarily changed unless otherwise specified.

The components of the voice-band extending apparatuses 100, 200, 300, and 400 depicted in FIGS. 1, 12, 15, and 20 are conceptual for describing functions, and not necessarily to be physically configured as depicted in the drawings. In other words, concrete forms of distribution and integration the voice-band extending apparatuses 100, 200, 300, and 400 are not limited to those depicted in the drawings, and all or part of the apparatus can be configured to be functionally or physically distributed and integrated in an arbitrary unit depending on various loads and conditions in use. For example, a signal unit can have the functions of the SNR calculation processing unit 120 and the band selecting unit 130.

Respective processing functions performed by the FFT unit 110, the SNR calculation processing units 120, 320, and 420, the band selecting units 130, 230, 330, and 430, the extension-signal creating units 140 and 340, the addition unit 150, and the IFFT unit 160 are to be implemented as follows. Precisely, all or an arbitrary part of these processing functions can be implemented by a central processing unit (CPU) and a computer program to be analyzed and executed by the CPU, or can be implemented as hardware by wired logic.

Moreover, the memory 470 corresponds to a semiconductor memory device, for example, a random access memory (RAM), a read-only memory (ROM), or a flash memory, or a storage device, such as a hard disk, or an optical disk.

According to an aspect of the technology disclosed by the present application, the sound quality can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A voice-band extending apparatus comprising:
an evaluating unit that evaluates one of a noise level and a signal noise ratio with respect to each of bands in an input signal that is input from an outside;
a band selecting unit that selects a band that includes few noises from the input signal based on an evaluation result by the evaluating unit;
a creating unit that creates an extension signal to extend a band in an input signal by using a signal of the band selected by the band selecting unit; and
an addition unit that adds the extension signal created by the creating unit to the input signal.

2. The voice-band extending apparatus according to claim 1, wherein the creating unit sets an application gain that varies in accordance with a frequency of the band selected by the band selecting unit, and applies set application gain to a signal of the band selected by the band selecting unit, thereby creating the extension signal.

3. The voice-band extending apparatus according to claim 1, wherein
the evaluating unit evaluates one of a noise level and a signal noise ratio with respect to each sub-band of which bandwidth to be evaluated is narrowed,
the band selecting unit selects a sub-band with few noises from the input signal based on an evaluation result by the evaluating unit, and
the creating unit creates the extension signal by using a signal of the sub-band selected by the band selecting unit.

4. The voice-band extending apparatus according to claim 1, further comprising a memory that stores therein an input signal that is input from an outside, wherein
the evaluating unit evaluates one of a noise level and a signal noise ratio with respect to each of bands in a past input signal stored by the memory, when the input signal does not include band with few noises, and
the band selecting unit selects a band with few noises from the past input signal based on an evaluation result by the evaluating unit.

5. A voice-band extending method to be executed by a computer, the voice-band extending method comprising:
evaluating one of a noise level and a signal noise ratio with respect to each of bands in an input signal that is input from an outside;
selecting a band that includes few noises from the input signal based on an evaluation result by processing of the evaluating of the noise level;
creating an extension signal to extend a band in an input signal by using a signal of the band selected by processing of the selecting of a band; and
adding the extension signal created by processing of the creating of the extension signal to the input signal.

6. The voice-band extending method according to claim 5, wherein the creating includes creating the extension signal by setting an application gain that varies in accordance with a frequency of the band selected at the selecting, and applying set application gain to a signal of the band selected at the selecting, thereby creating the extension signal.

7. The voice-band extending method according to claim 5, wherein
the evaluating includes evaluating one of a noise level and a signal noise ratio with respect to each sub-band of which bandwidth to be evaluated is narrowed,
the selecting includes selecting a sub-band with few noises from the input signal based on an evaluation result at the evaluating, and
the creating includes creating the extension signal by using a signal of the sub-band selected at the selecting.

8. The voice-band extending method according to claim 5, wherein
the evaluating includes evaluating one of a noise level and a signal noise ratio with respect to each of bands in a past input signal stored by a memory that stores therein an input signal that is input from an outside, when the input signal does not include band with few noises, and
the selecting includes selecting a band with few noises from the past input signal based on an evaluation result at the evaluating.
